(19) United States
(12) Patent Application Publication
(10) Pub. No.: US 2023/0196493 A1
(43) Pub. Date: Jun. 22, 2023

(54) SEAT MANAGEMENT METHOD, SEAT MANAGEMENT SYSTEM, AND STORAGE MEDIUM

(71) Applicant: TOYOTA JIDOSHA KABUSHIKI KAISHA, Toyota-shi Aichi-ken (JP)

(72) Inventors: Taizo MASUDA, Yokohama-shi Kanagawa-ken (JP); Ryota TOMIZAWA, Mishima-shi Shizuoka-ken (JP); Sei MIYAZAKI, Susono-shi Shizuoka-ken (JP); Yuki NISHIKAWA, Susono-shi Shizuoka-ken (JP)

(73) Assignee: TOYOTA JIDOSHA KABUSHIKI KAISHA, Toyota-shi Aichi-ken (JP)

(21) Appl. No.: 17/962,883

(22) Filed: Oct. 10, 2022

(30) Foreign Application Priority Data
Dec. 21, 2021 (JP) 2021-206805

(51) Int. Cl. G06Q 50/30; G06F 16/23

(52) U.S. Cl. CPC G06Q 50/30; G06F 16/2358

(57) ABSTRACT

A seat management method includes determining whether there is a priority passenger at a platform who is a passenger in need of a seat in a vehicle, acquiring a seating status of a vehicle arriving at the platform, allocating a seat to the priority passenger based on the acquired seating status when it is determined that there is the priority passenger, and notifying inside of the vehicle of the allocated seat. In the notification process, when there is a boarded passenger who is a passenger sitting in the allocated seat, a first time point at which the priority passenger starts to use the allocated seat and a second time point at which the boarded passenger ends use of the allotted seat are compared, and the boarded passenger is notified that the seat is unavailable, provided that the second time point is later than the first time point.

### CROSS-REFERENCE TO RELATED APPLICATION

This application claims priority to Japanese Patent Application No. 2021-206805 filed on Dec. 21, 2021, incorporated herein by reference in its entirety.

### BACKGROUND

### 1. Technical Field

The present disclosure relates to technical fields of a seat management method, a seat management system, and a storage medium which manage a seat in a vehicle used as, for example, public transportation.

### 2. Description of Related Art

As a method of this kind, a method has been proposed in which a priority seat of, for example, a train can be reserved at the time of ticket purchase, and when the priority seat is reserved, the reservation details are displayed in a vehicle having the reserved priority seat (see Japanese Unexamined Patent Application Publication No. 2004-178292 (JP 2004-178292 A)).

### SUMMARY

In the technique described in JP 2004-178292 A, a user who wants to reserve a priority seat needs a priority card issued by a local government or the like (for example, a silver card, a card that proves that they are physically handicapped) in advance to prove that they need the priority seat. In other words, when the user does not have a priority card, they cannot reserve a priority seat even if they need a priority seat. That is, the technique described in JP 2004-178292 A may not be sufficiently convenient for a person who needs a priority seat.

The present disclosure provides a seat management method, a seat management system, and a storage medium that can improve the convenience of a person who needs a priority seat.

A seat management method according to a first aspect of the present disclosure includes a determination process of determining whether there is a priority passenger at a platform who is a passenger in need of a seat in a vehicle, an acquisition process of acquiring a seating status of a vehicle arriving at the platform, an allocation process of allocating, upon determining that there is the priority passenger in the determination process, a seat to the priority passenger based on the acquired seating status, and a notification process of notifying inside of the vehicle of the allocated seat. In the notification process, when there is a boarded passenger who is a passenger already sitting in the allocated seat, a first time point at which the priority passenger starts to use the allocated seat and a second time point at which the boarded passenger ends use of the allotted seat are compared, and the boarded passenger is notified that the allocated seat is unavailable, provided that the second time point is later than the first time point.

A seat management system according to a second aspect of the present disclosure includes a determination unit that determines whether there is a priority passenger at a platform who is a passenger in need of a seat in a vehicle, an acquisition unit that acquires a seating status of a vehicle arriving at the platform, an allocation unit that allocates, when the determination unit determines that there is the priority passenger, a seat to the priority passenger based on the acquired seating status, and a notification unit that notifies inside of the vehicle of the allocated seat. The notification unit is configured to, when there is a boarded passenger who is a passenger sitting in the allocated seat, compare a first time point at which the priority passenger starts to use the allocated seat and a second time point at which the boarded passenger ends use of the allotted seat, and notify the boarded passenger that the allocated seat is unavailable, provided that the second time point is later than the first time point.

A storage medium according to a third aspect of the present disclosure stores a computer program that causes a computer to function as a determination unit that determines whether there is a priority passenger at a platform who is a passenger in need of a seat in a vehicle, an acquisition unit that acquires a seating status of a vehicle arriving at the platform, an allocation unit that allocates, when the determination unit determines that there is the priority passenger, a seat to the priority passenger based on the acquired seating status, and a notification unit that notifies inside of the vehicle of the allocated seat, compares, when there is a boarded passenger who is a passenger sitting in the allocated seat, a first time point at which the priority passenger starts to use the allocated seat and a second time point at which the boarded passenger ends use of the allotted seat, and notifies the boarded passenger that the allocated seat is unavailable, provided that the second time point is later than the first time point.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a seat management system according to an embodiment;

FIG. 2 is a flowchart illustrating an operation of a server according to the embodiment; and

FIG. 3 is a block diagram illustrating a configuration of a computer according to the embodiment.

### DETAILED DESCRIPTION OF EMBODIMENTS

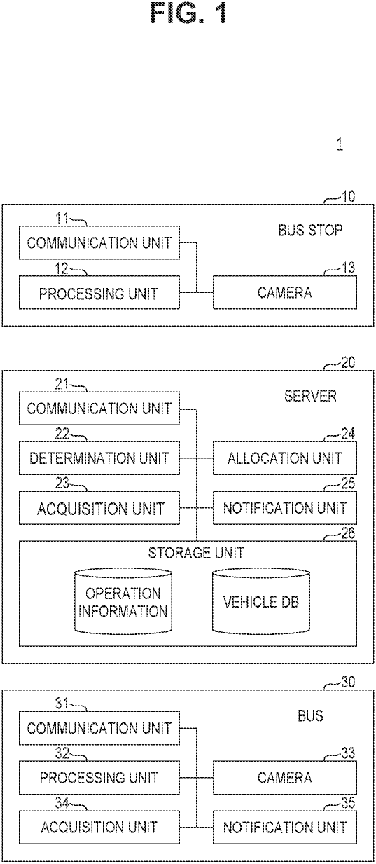

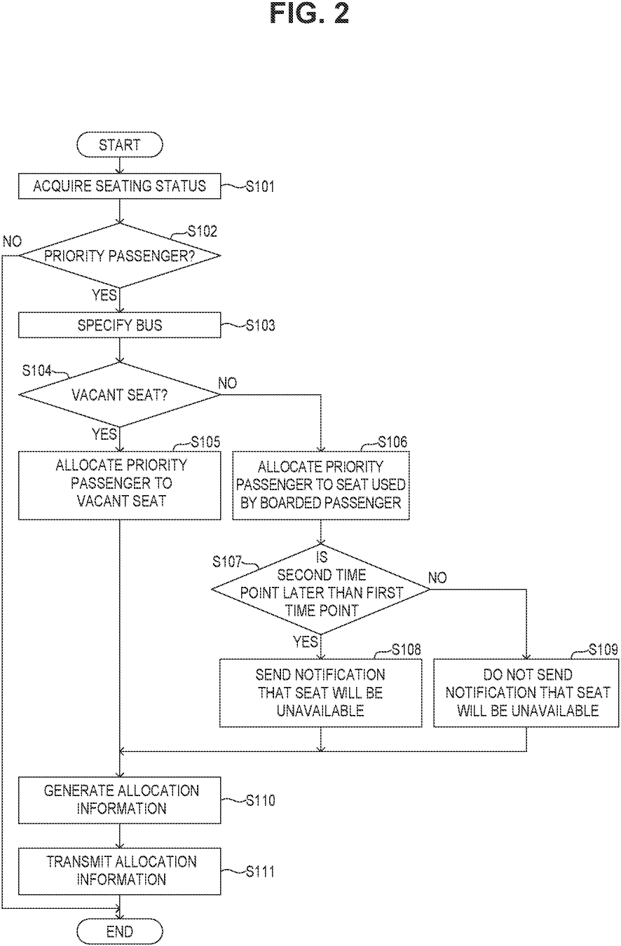

An embodiment relating to a seat management method will be described with reference to FIGS. 1 and 2. In the following embodiment, a seat management method for a fixed-route bus will be given as an example. However, the seat management method according to the embodiment can be applied not only to a fixed-route bus but also to a train or the like.

In FIG. 1, a seat management system 1 includes a bus stop 10, a server 20, and a bus 30. Each of the bus stop 10 and the bus 30 can communicate with the server 20 via a network such as the Internet.

The bus stop 10 has a communication unit 11, a processing unit 12, and a camera 13. The camera 13 may be arranged, for example, on a guide display board of the bus stop 10, a shed (that is, a roof structure), or the like. The camera 13 captures images the surroundings of the bus stop 10 (particularly, a person waiting for a bus at the bus stop 10).

The processing unit 12 sequentially transmits the images captured by the camera 13 to the server 20 via the communication unit 11. In this case, the processing unit 12 may transmit all the images captured by the camera 13 to the server 20, or may transmit only a portion of the images to the server 20.

The bus 30 has a communication unit 31, a processing unit 32, a camera 33, an acquisition unit 34, and a notification unit 35. The camera 33 is arranged so as to be able to capture an image of inside of the bus 30. The processing unit 32 sequentially transmits the images captured by the camera 33 to the server 20 via the communication unit 31. In this case, the processing unit 32 may transmit all the images captured by the camera 33 to the server 20, or may transmit only a portion of the images to the server 20. The bus 30 may be an autonomous driving bus.

The notification unit 35 sends notification to the inside of the bus 30 according to the allocation information transmitted from the server 20 described below. The acquisition unit 34 acquires alighting information (for example, the name and identification number of an alighting stop) of a passenger using a seat in the bus 30 in association with the seat. The acquisition unit 34 transmits the acquired alighting information to the server 20 via the communication unit 31.

For example, a touch panel may be provided on each seat of the bus 30, and passengers may be able to input an alighting stop using the touch panel. In this case, the acquisition unit 34 may acquire information indicating the alighting stop input from using the touch panel as the alighting information of the passenger sitting in the seat provided with the touch panel. The bus 30 may be capable of short-range communication with a mobile terminal (for example, a smart phone) possessed by a passenger. Passengers shall input the alighting stop to the mobile terminal when occupying a seat. In this case, the acquisition unit 34 may acquire information indicating the alighting stop input to the mobile terminal as the alighting information of the passenger who possesses the mobile terminal. Examples of short-range communication include infrared communication, Bluetooth (registered trademark), Wi-Fi (registered trademark), near field communication (NFC), and the like.

The touch panel described above may be provided only in priority seats (including wheelchair seats) of the bus 30. Alternatively, the touch panel described above may be provided in all the seats of the bus 30. In this case, passengers using priority seats are required to input the alighting stop using the touch panel, whereas passengers using general seats may arbitrarily input the alighting stop using the touch panel.

It may be mandatory to input the alighting stop at which the passenger wishes to alight to the mobile terminal only when the passenger uses the priority seat of the bus 30. When the passenger uses a general seat of the bus 30, the input of the alighting stop at which the passenger wishes to alight to the mobile terminal may be optional.

For example, the priority seat may be a foldable seat. Then, the priority seat may be configured to be deployed only when the passenger using the priority seat inputs the name of the alighting stop at which the passenger wishes to alight. In addition, some privilege may be given to the passenger who has input the alighting stop at which the passenger wishes to alight (that is, provided the alighting information).

The server 20 has a communication unit 21, a determination unit 22, an acquisition unit 23, an allocation unit 24, a notification unit 25, and a storage unit 26 as a logical block logically realized inside the server 20 or as a processing circuit physically realized. The storage unit 26 stores, for example, operation information, a vehicle database, and the like.

The operation information includes, for example, information (operation plan of the route, name and identification number of each bus stop, position, timetable, and the like) related to the route, and information (type, location, presence or absence of delay, and the like of each bus) related to the bus in operation. The vehicle database contains, for example, information (capacity, number of seats, number of priority seats, presence or absence of an incline, presence or absence of wheelchair seats, and the like) related to the bus in association with the type (non-step bus, or the like) of bus.

The determination unit 22 determines whether there is a priority passenger who is a passenger in need of a seat at the bus stop 10 by performing predetermined image processing on the image (that is, the image captured by the camera 13) received from the bus stop 10 via the communication unit 21. The determination unit 22 may recognize, for example, a passenger holding a cane (including a white cane and a crutch), a passenger that has a sign that indicates they are pregnant or in need of help, a passenger using a wheelchair, and a passenger carrying a guide dog as priority passengers. The existing image processing used for image recognition such as pattern matching processing may be applied to the predetermined image processing described above.

The acquisition unit 23 acquires the seating status related to the bus 30 based on the image (that is, the image captured by the camera 33) received from the bus 30 via the communication unit 21. Since existing techniques such as an image-based position identification technique can be applied to the technique for acquiring the seating status, the details thereof will be omitted. For example, a seating sensor may be provided in each seat of the bus 30. The processing unit 32 of the bus 30 may transmit information indicating the detection result of the seating sensor of each seat to the server 20 via the communication unit 31. The acquisition unit 23 may acquire the seating status related to the bus 30 from the information indicating the detection result of the seating sensor of each seat of the bus 30 in place of or in addition to the image described above.

The allocation unit 24 allocates a seat to the priority passenger when the determination unit 22 determines that there is a priority passenger at the bus stop 10. In particular, when it is determined that there is a priority passenger at the bus stop 10, the allocation unit 24 refers to the operation information and identifies the bus (in other words, the bus that the priority passenger is expected to board) that will arrive at the bus stop 10 in the near future. Here, it is assumed that the specified bus is the bus 30.

Next, the allocation unit 24 determines whether there is a vacant seat in the bus 30 by referring to the seating status related to the bus 30 acquired by the acquisition unit 23 and the information related to the bus corresponding to the bus 30 included in the vehicle database. When it is determined that there are vacant seats, the allocation unit 24 allocates vacant seats to priority passengers. For example, when both the priority seat and the general seat are vacant, the allocation unit 24 may allocate the vacant priority seat to a priority passenger.

When it is determined that the bus 30 has no vacant seats, the allocation unit 24 allocates, from among the seats of the bus 30, the seat that has the above-described alighting information to the priority passenger. In this case, the allocation unit 24 may allocate the priority seat to the priority passenger, or may allocate the seat used by a passenger who alights soon from the bus to the priority passenger by referring to the alighting information, for example. When the priority passenger is using a wheelchair, the allocation unit 24 allocates a wheelchair seat as the priority seat to the priority passenger. Further, when there is a seat allocated to another priority passenger, the allocation unit 24 may exclude the seat from candidates for a seat to be allocated to the priority passenger.

The notification unit 25 transmits the allocation information indicating the seat allocated by the allocation unit 24 to the bus (here, the bus 30) having the allocated seat via the communication unit 21. In addition to the allocated seat, the allocation information may include, for example, a bus stop (here, the bus stop 10) where the priority passenger boards the bus.

As described above, the notification unit 35 of the bus 30 sends the notification to the inside of the bus 30 according to the allocation information transmitted from the server 20. The notification unit 35 notifies a driver of the bus 30, for example, that there is a priority passenger, and notifies the driver of the bus 30 of the need for assistance, the bus stop at which the priority passenger will board, the allocated seat, and the like. For example, when the priority passenger has a white cane or a crutch, is in a wheelchair, or is carrying a guide dog, the driver of the bus 30 may be notified that assistance is needed. It should be noted that “assistance” is a concept that is not limited to directly helping a priority passenger to board the bus 30, but also includes, for example, calling out to passengers in the bus 30 and passengers and vehicles in the vicinity of the bus 30.

In addition, the notification unit 35 may notify a passenger (hereinafter, appropriately referred to as “boarded passenger”) who is using the seat allocated to the priority passenger indicated by the allocation information that the seat will not be available. For example, when the seat is provided with a touch panel, the notification unit 35 may notify the boarded passenger by displaying letters or images indicating that the seat will not be available on the touch panel (that is, the display unit). In this case, information on the bus stop (here, the bus stop 10) from which the seat becomes unavailable may be displayed on the touch panel.

For example, when the seat is provided with a green lamp and a red lamp, the notification unit 35 may notify the boarded passenger that the seat will not be available by turning off the green lamp and turning on the red lamp. In this case, the notification unit 35 may notify the passenger that the seat is available by turning off the red lamp and turning on the green lamp.

When the bus 30 can communicate with the mobile terminal possessed by the boarded passenger, the notification unit 35 may notify the boarded passenger by transmitting information indicating that the seat will be unavailable to the mobile terminal via the communication unit 31. In this case, information indicating a bus stop (here, the bus stop 10) in which the seat becomes unavailable may be transmitted to the mobile terminal.

A passenger (that is, a boarded passenger) using a seat allocated to a priority passenger may alight from the bus 30 (that is, end the use of the seat) before the priority passenger boards the bus 30. In this case, when the boarded passenger is notified that the seat will not be available, the boarded passenger may feel frustrated.

Therefore, when the notification unit 25 of the server 20 generates the allocation information, for example, the bus stop 10 at which the priority passenger boards the bus 30 and the alighting stop at which the boarded passenger alights from the bus 30 based on the alighting information are compared. When the alighting stop is a bus stop that the bus 30 passes after arriving at the bus stop 10, the notification unit 25 includes information (for example, a flag) indicating that a notification indicating that the seat will be unavailable to the boarded passenger is required in the allocation information.

When the alighting stop is a bus stop that the bus 30 passes before arriving at the bus stop 10, the notification unit 25 may include information (for example, a flag) indicating that the notification indicating that the seat will be unavailable to the boarded passenger is not necessary in the allocation information. When the alighting stop is the bus stop 10, the boarded passenger will end the use of the seat before the priority passenger reaches the allocated seat. Thus, the notification unit 25 may include information indicating that the notification indicating that the seat will be unavailable to the boarded passenger is not necessary in the allocation information. In these cases, the notification unit 25 may include information (for example, a flag) indicating that the boarded passenger may be notified that the seat is available in the allocation information.

That is, the notification unit 25 compares a first time point at which the priority passenger begins to use the allocated seat with a second time point at which the boarded passenger ends the use of that seat, and then when the second time point is later than the first time point, the notification unit 25 includes information indicating that the notification indicating that the seat will be unavailable to the boarded passenger is required in the allocation information.

The notification unit 35 of the bus 30 notifies the boarded passenger that the seat will be unavailable when the allocation information includes information indicating that the notification indicating that the seat will be unavailable to the boarded passenger is required. On the other hand, the notification unit 35 does not notify the boarded passenger that the seat will be unavailable when the allocation information includes information indicating that the notification that the seat will be unavailable to the boarded passenger is not necessary. The notification unit 35 notifies the boarded passenger that the seat is available when the allocation information includes information indicating that the boarded passenger may be notified that the seat is available.

For example, when the seat of the bus 30 is provided with a green lamp and a red lamp, the notification unit 35 may perform the following operations. That is, when the allocation information includes information indicating that the notification indicating that the seat will not be available to the boarded passenger is required, the bus 30 turns off the green lamp and turns on the red lamp of the seat used by the boarded passenger at only a predetermined time before the bus 30 arrives at the bus stop 10 where the priority passenger boards the bus 30, in such a manner that the boarded passenger may be notified that the seat will be unavailable. When the allocation information includes information indicating that the notification indicating that the seat will be unavailable to the boarded passenger is not necessary, the notification unit 35 may turn off the green lamp and turn on the red lamp of the seat used by the boarded passenger after the bus 30 arrives at the bus stop where the boarded passenger alights from the bus 30 (as a result, the boarded passenger will not be notified that the seat will be unavailable).

When the priority passenger is allocated a vacant seat, the notification unit 35 notifies the passengers around the seat that the seat is unavailable according to the allocation information. For example, when the seat of the bus 30 is provided with a touch panel, the notification unit 35 may notify the passengers that the seat is unavailable on the touch panel by displaying letters or images indicating that the seat is unavailable. For example, when the seat of the bus 30 is provided with a green lamp and a red lamp, the notification unit 35 may notify the passengers that the seat is unavailable by turning off the green lamp and turning on the red lamp.

Next, the operation of the server 20 will be described with reference to the flowchart of FIG. 2. In FIG. 2, the acquisition unit 23 acquires the seating status of each of a plurality of buses including the bus 30 (step S101). The acquisition unit 23 may sequentially acquire the seating status regardless of the processing after step S102. In parallel with or before and after the processing of step S101, the determination unit 22 determines whether there is a priority passenger at the bus stop 10 (step S102).

When it is determined in the process of step S102 that there is no priority passenger at the bus stop 10 (step S102: No), the operation illustrated in FIG. 2 is ended. After that, the process of step S101 may be performed again. The operation illustrated in FIG. 2 may be repeated.

When it is determined in the process of step S102 that there is a priority passenger at the bus stop 10 (step S102: Yes), the allocation unit 24 refers to the operation information of the storage unit 26 and specifies the bus on which the priority passenger of the bus stop 10 is expected to board (step S103). Here, it is assumed that the specified bus is the bus 30.

Next, the allocation unit 24 determines whether there is a vacant seat on the bus 30 with reference to the seating status related to the bus 30 acquired in the process of step S102 and the information on the bus corresponding to the bus 30 included in the vehicle database of the storage unit 26 (step S104). When it is determined in the process of step S104 that there is a vacant seat (step S104: Yes), the allocation unit 24 allocates the vacant seat to the priority passenger (step S105).

When it is determined in the process of step S104 that there is no vacant seat on the bus 30 (step S104: No), the allocation unit 24 allocates, from among seats of the bus 30, the seat that has the above-described alighting information to the priority passenger (step S106).

After the process of step S106, the notification unit 25 estimates, based on the bus stop 10 where the priority passenger boards the bus 30, a first time point at which the priority passenger starts to use the allocated seat. The notification unit 25 estimates, based on the alighting stop at which the boarded passenger alights from the bus 30 based on the alighting information, a second time point at which the boarded passenger ends the use of the seat. Then, the notification unit 25 determines whether the second time point is later than the first time point (step S107).

When it is determined in the process of step S107 that the second time point is later than the first time point (step S107: Yes), the notification unit 25 determines to notify the boarded passenger that the seat will be unavailable (step S108). On the other hand, when it is determined in the process of step S107 that the second time point is earlier than the first time point (step S107: No), the notification unit 25 determines not to send a notification indicating that the seat will be unavailable, or determines to send a notification indicating that the seat is available to the boarded passenger (step S109).

The notification unit 25 then generates allocation information indicating the seat allocated by the allocation unit 24 (step S110). In the process of step S110 performed after the process of step S108, the notification unit 25 includes, in the allocation information, information indicating that a notification indicating that the seat will be unavailable is required. In the process of step S110 performed after the process of step S109, the notification unit 25 includes, in the allocation information, information indicating that the notification indicating that the seat will be unavailable is not necessary or information indicating that the notification that the seat is available may be sent. The notification unit 25 transmits the generated allocation information to the bus 30 via the communication unit 21 (step S111).

### Technical Effect

In the seat management system 1, it is determined from the image captured by the camera 13 of the bus stop 10 whether there is a priority passenger at the bus stop 10. When it is determined that there is a priority passenger at the bus stop 10, a seat is automatically allocated to the priority passenger. That is, in the seat management system 1, a seat is automatically prepared as long as a person corresponding to the priority passenger goes to the bus stop 10. Therefore, according to the seat management system 1, it is possible to improve the convenience of a person (corresponding to the priority passenger) who needs a priority seat.

In the seat management system 1, whether the person is a priority passenger is determined from the image (that is, from the appearance of the person). Therefore, it is difficult for the seat management system 1 to specify the age of the passenger (for example, it is difficult to specify an elderly passenger). For example, it is possible to consider situations where an elderly person does not necessarily need a priority seat, and the number of seats on the bus 30 is limited. In view of those situations, it can be said that the seat management system 1 that specifies a priority passenger from an image can select a person (that is, the person with the higher priority) who is more in need of a priority seat and allocate a seat to the selected person.

In the seat management system 1, the first time point at which the priority passenger starts to use the allocated seat and the second time point at which the boarded passenger ends the use of the seat are compared. Then, when the second time point is later than the first time point, the boarded passenger is notified that the seat will be unavailable. On the other hand, when the second time point is earlier than the first time point (in other words, when the first time point is after the second time point), the boarded passenger will not be notified that the seat will be unavailable, or the boarded passenger will be notified that the seat will be available.

Therefore, the boarded passenger can recognize that the seat is available until it is notified that the seat will be unavailable. Therefore, the boarded passenger can use the seat (particularly the priority seat) with peace of mind until a notification is sent indicating that the seat will be unavailable. In addition, when the second time point is earlier than the first time point, the boarded passenger will not be notified that the seat will be unavailable. Therefore, it is possible to prevent the boarded passenger from feeling frustrated due to the notification.

### Computer Program

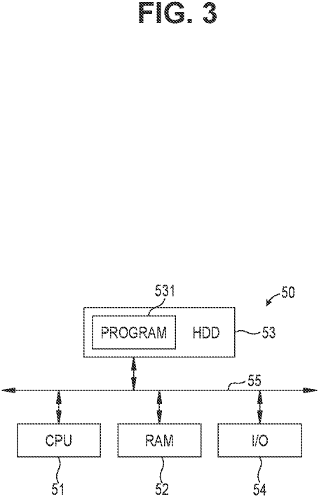

An embodiment of a computer program will be described with reference to FIG. 3. FIG. 3 is a block diagram illustrating a configuration of a computer according to the embodiment.

In FIG. 3, a computer 50 includes a central processing unit (CPU) 51, a RAM 52, a hard disk drive (HDD) 53, and an input / output (I/O) 54. The CPU 51, the RAM 52, the HDD 53, and the I/O 54 are connected to each other by a bus 55. A computer program 531 according to the embodiment is stored in the HDD 53 in advance.

The processing of the CPU 51 by the computer program 531 will be described. The CPU 51 acquires the seating status of each of a plurality of buses including the bus 30. Further, the CPU 51 determines whether there is a priority passenger at the bus stop 10. When it is determined that there is a priority passenger at the bus stop 10, the CPU 51 refers to the operation information and specifies the bus on which the priority passenger at the bus stop 10 is expected to board. Here, it is assumed that the specified bus is the bus 30.

Next, the CPU 51 determines whether there is a vacant seat in the bus 30 by referring to the seating status related to the bus 30 and the information related to the bus corresponding to the bus 30 included in the vehicle database. When it is determined that there is a vacant seat, the CPU 51 allocates the vacant seat to the priority passenger. When it is determined that the bus 30 has no vacant seat, the CPU 51 allocates, from among the seats of the bus 30, the seat that has the above-described alighting information to the priority passengers.

The CPU 51 estimates, based on the bus stop 10 where the priority passenger boards the bus 30, a first time point at which the priority passenger starts to use the allocated seat. The CPU 51 estimates, based on the alighting stop at which the boarded passenger alights from the bus 30 based on the alighting information, a second time point at which the boarded passenger ends the use of the seat. Then, the CPU 51 determines whether the second time point is later than the first time point.

When it is determined that the second time point is later than the first time point, the CPU 51 decides to notify the boarded passenger that the seat will be unavailable. On the other hand, when it is determined that the second time point is earlier than the first time point, the CPU 51 decides not to send a notification indicating that the seat is unavailable, or decides to send a notification indicating that the seat is available to the boarded passenger.

Then, the CPU 51 generates allocation information indicating the seat allocated to the priority passenger. In this case, when it is determined that the second time point is later than the first time point, the CPU 51 includes information indicating that a notification indicating that the seat will be unavailable is required in the allocation information. When it is determined that the second time point is earlier than the first time point, the CPU 51 includes, in the allocation information, information indicating that the notification indicating that the seat will be unavailable is not necessary, or information indicating that the notification that the seat is available may be sent. The CPU 51 transmits the generated allocation information to the bus 30.

The operation information and the vehicle database may be stored in the HDD 53. That is, the storage unit 26 of the server 20 may be realized by the HDD 53.

The computer program 531 may be stored in the HDD 53 by the computer 50 reading the computer program 531 from a recording medium such as an optical disc such as a compact disc read only memory (CD-ROM) for storing the computer program 531, and a universal serial bus (USB) memory. Alternatively, the computer program 531 may be stored in the HDD 53 by the computer 50 downloading the computer program 531 via a network such as the Internet.

According to the computer program 531, it is possible to improve the convenience of a person who needs a priority seat, similar to the seat management method described above. In addition, the boarded passenger can use the seat (especially the priority seat) with peace of mind until it is notified that the seat will be unavailable. In addition, it is possible to prevent the boarded passenger from feeling frustrated due to the notification. According to the computer program 531, the server 20 in the above-described embodiment can be realized relatively easily.

Various aspects of the disclosure derived from the embodiments described above will be described below.

A seat management method according to a first aspect of the disclosure includes a determination process of determining whether there is a priority passenger at a platform who is a passenger in need of a seat in a vehicle, an acquisition process of acquiring a seating status of a vehicle arriving at the platform, an allocation process of allocating, upon determining that there is the priority passenger in the determination process, a seat to the priority passenger based on the acquired seating status, and a notification process of notifying inside of the vehicle of the allocated seat. In the notification process, when there is a boarded passenger who is a passenger sitting in the allocated seat, a first time point at which the priority passenger starts to use the allocated seat and a second time point at which the boarded passenger ends use of the allotted seat are compared, and the boarded passenger is notified that the allocated seat is unavailable, provided that the second time point is later than the first time point. In the above-described embodiment, “bus stop 10” corresponds to an example of “platform”, and “bus 30” corresponds to an example of “vehicle”.

In the notifying, when there is the boarded passenger, the boarded passenger may be notified that the allocated seat is available, provided that the second time point is earlier than the first time point.

Alternatively, in the notifying, when there is the boarded passenger, the notification does not have to be sent to the boarded passenger, provided that the second time point is earlier than the first time point.

In the allocation process, a priority seat may be allocated to the priority passenger.

In the determination process, whether there is the priority passenger may be determined based on an image of the platform.

A seat management system according to a second aspect of the disclosure includes a determination unit that determines whether there is a priority passenger at a platform who is a passenger in need of a seat in a vehicle, an acquisition unit that acquires a seating status of a vehicle arriving at the platform, an allocation unit that allocates, when the determination unit determines that there is the priority passenger, a seat to the priority passenger based on the acquired seating status, and a notification unit that notifies inside of the vehicle of the allocated seat. The notification unit, when there is a boarded passenger who is a passenger sitting in the allocated seat, compares a first time point at which the priority passenger starts to use the allocated seat and a second time point at which the boarded passenger ends use of the allotted seat, and notifies the boarded passenger that the allocated seat is unavailable, provided that the second time point is later than the first time point.

In the embodiment described above, “server 20” corresponds to an example of “seat management system”, “determination unit 22” corresponds to an example of “determination unit”, “acquisition unit 23” corresponds to an example of “acquisition unit”, “allocation unit 24” corresponds to an example of “allocation unit”, and “notification unit 25” corresponds to an example of “notification unit”.

A storage medium according to a third aspect of the disclosure stores a computer program that causes a computer to function as a determination unit that determines whether there is a priority passenger at a platform who is a passenger in need of a seat in a vehicle, an acquisition unit that acquires a seating status of a vehicle arriving at the platform, an allocation unit that allocates, when the determination unit determines that there is the priority passenger, a seat to the priority passenger based on the acquired seating status, and a notification unit that notifies inside of the vehicle of the allocated seat. The notification unit, when there is a boarded passenger who is a passenger sitting in the allocated seat, compares a first time point at which the priority passenger starts to use the allocated seat and a second time point at which the boarded passenger ends use of the allotted seat, and notifies the boarded passenger that the allocated seat is unavailable, provided that the second time point is later than the first time point.

Each aspect of the present disclosure is not limited to the above-described embodiment, and can be appropriately modified as long as it does not contradict the gist or idea of the present disclosure that can be read from the claims and the entire specification. Further, seat management methods, seat management systems, and storage media storing computer programs with such modifications are also within the technical scope of the present disclosure.

1. A seat management method comprising:
a determination process of determining whether there is a priority passenger at a platform who is a passenger in need of a seat in a vehicle;
an acquisition process of acquiring a seating status of a vehicle arriving at the platform;
an allocation process of allocating, upon determining that there is the priority passenger in the determination process, a seat to the priority passenger based on the acquired seating status; and
a notification process of notifying inside of the vehicle of the allocated seat,
wherein, in the notification process, when there is a boarded passenger who is a passenger already sitting in the allocated seat, a first time point at which the priority passenger starts to use the allocated seat and a second time point at which the boarded passenger ends use of the allotted seat are compared, and the boarded passenger is notified that the allocated seat is unavailable, provided that the second time point is later than the first time point.

2. The seat management method according to claim 1, wherein, in the notification process, when there is the boarded passenger, the boarded passenger is notified that the allocated seat is available, provided that the second time point is earlier than the first time point.

3. The seat management method according to claim 1, wherein, in the notification process, when there is the boarded passenger, notification is not sent to the boarded passenger, provided that the second time point is earlier than the first time point.

4. The seat management method according to claim 1, wherein, in the allocation process, a priority seat is allocated to the priority passenger.

5. The seat management method according to claim 1, wherein, in the determination process, whether there is the priority passenger is determined based on a captured image of the platform.

6. A seat management system comprising:
a determination unit that determines whether there is a priority passenger at a platform who is a passenger in need of a seat in a vehicle;
an acquisition unit that acquires a seating status of a vehicle arriving at the platform;
an allocation unit that allocates, when the determination unit determines that there is the priority passenger, a seat to the priority passenger based on the acquired seating status; and
a notification unit that notifies inside of the vehicle of the allocated seat,
wherein the notification unit is configured to, when there is a boarded passenger who is a passenger sitting in the allocated seat, compare a first time point at which the priority passenger starts to use the allocated seat and a second time point at which the boarded passenger ends use of the allotted seat, and notify the boarded passenger that the allocated seat is unavailable, provided that the second time point is later than the first time point.

7. A non-transitory storage medium storing a computer program that causes a computer to function as:
a determination unit that determines whether there is a priority passenger at a platform who is a passenger in need of a seat in a vehicle;
an acquisition unit that acquires a seating status of a vehicle arriving at the platform;
an allocation unit that allocates, when the determination unit determines that there is the priority passenger, a seat to the priority passenger based on the acquired seating status; and
a notification unit that notifies inside of the vehicle of the allocated seat, compares, when there is a boarded passenger who is a passenger sitting in the allocated seat, a first time point at which the priority passenger starts to use the allocated seat and a second time point at which the boarded passenger ends use of the allotted seat, and notifies the boarded passenger that the allocated seat is unavailable, provided that the second time point is later than the first time point.
